(19) United States
(12) Patent Application Publication
(10) Pub. No.: US 2005/0215456 A1
(43) Pub. Date: Sep. 29, 2005

(54) Manufacturing method of monoglyceride sulfonate, toilet soap composition using the same, and manufacturing method of toilet soap composition comprising salt

(76) Inventors: Je-Kwon Goo, Daejeon-city (KR); Soo-Gyu Choi, Daejeon-city (KR); Kyeong-Woo Hong, Daejeon-city (KR); Joo-Young Oh, Daejeon-city (KR); Moon-Jeong Rang, Daejeon-city (KR); Yeo-Kyung Yoon, Daejeon-city (KR); Tae-Sung Kim, Daejeon-city (KR); Jung-Jin Choi, Daejeon-city (KR)

Correspondence Address: LADAS & PARRY, 5670 WILSHIRE BOULEVARD, SUITE 2100, LOS ANGELES, CA, 90036-5679, US

(21) Appl. No.: 10/509,537

(22) PCT Filed: Mar. 28, 2003
(86) PCT No.: PCT/KR03/00633

§ 371 Date: May 16, 2005

(30) Foreign Application Priority Data
Mar. 29, 2002 (KR) 10-2002-0017393
Mar. 29, 2002 (KR) 10-2002-0017417
Dec. 23, 2002 (KR) 10-2002-0082938

(51) Int. Cl. C11D 17/00

(52) U.S. Cl. 510/424

(57) ABSTRACT

The present invention relates to a method for preparing monoglyceride sulfonate that is useful for a cleansing agent for a human body, economically in a large amount, from an inexpensive fatty acid using a convenient manufacturing unit. The present invention also provides a soft soap composition comprising monoglyceride sulfonate and a fatty acid soap, which has superior molding and stamping workability, softness, smoothness, foamability, and moisturizing ability. The present invention also provides a method for preparing a salt-containing soft soap using the fatty acid used for preparation of the monoglyceride sulfonate, which contains a lot of salt, so that is softens skin, easily removes waste materials, prevents irritation, promotes blood circulation, and prevents depilation and dandruff.

### BACKGROUND OF THE INVENTION

(a) Field of the Invention

The present invention relates to a method for preparing monoglyceride sulfonate, and more particularly to a method for economically preparing monoglyceride sulfonate from an inexpensive fatty acid. The present invention also relates to a soft soap composition comprising monoglyceride sulfonate, which includes lauric acid and myristic acid, as a cleansing ingredient, so that it offers good molding and stamping workability during soap manufacturing, and superior softness, smoothness, foamability, and moisturizing ability during use of the soap. The present invention also relates to a method for preparing a salt-containing soft soap containing a large amount of salt, so that it offers a skin conditioning effect, easily removes waste materials, promotes blood circulation, and prevents depilation and dandruff, using the fatty acid.

(b) Description of the Related Art

Monoalkylglyceryl sulfonate is known as an anionic surfactant U.S. Pat. No. 3,960,782 discloses use of monoalkylglyceryl sulfonate as an ingredient of a shampoo composition. The patent synthesizes 2,3-epoxy-1-propanesulfonic acid from epichlorohydrin and sodium bisulfite, and neutralizes it with sodium hydroxide to prepare sodium 2,3-dihydroxy-1-propanesulfonate. Then, monoalkylglyceryl sulfonate is prepared by esterifying it with a fatty acid. This method requires a relatively high reaction temperature and an excess amount of fatty acid, and the excess unreacted fatty acid should be removed by filtration using an organic solvent or distillation using a vacuum suction unit, afterwards. The fatty acid should be added at the beginning to inhibit foaming during the reaction. Moreover, handling and control of preparation equipment is difficult, and the reaction yield is not very good because the fatty acid reacts with a salt that is insoluble to the fatty acid.

There is a method of synthesizing 3-chloro-2-hydroxypropyl alkyl ester from fatty acid and epichlorohydrin, and substituting the chloride group to a sulfonate group by the Strecker Reaction using sodium sulfite and sodium bisulfite. This method has a problem in that the reaction yield is not very good due to an intramolecular ester linkage and hydrolysis of the chloride.

A soft soap composition should have such good binding ability and plasticity that it can be easily prepared into a solid soap using a fatty acid soft soap manufacturing unit. It should have good hardness and solubility, lest the soap be softened or worm, and it should have foamability, foaming stability, and surface touch comparable to those of the general fatty acid soft soap. Also, it should not cause skin irritation and trouble after use of the soap.

The general soap used for body cleansing is a fatty acid soap prepared by saponification of fat or fatty acid, obtained by decomposition of fat, with potassium hydroxide, sodium hydroxide, and so forth. This fatty acid soap is alkaline in water, and therefore it may remove seba of the skin too excessively and softens the horny layer, if used frequently. As a result, the skin may become dry and less elastic, so that it readily roughens or skin irritation arises. For this reason, many additives supplying moisture and oil to the skin have been used to solve the skin dryness and roughness problems due to use of an alkaline soap.

For example, there is an attempt to prevent skin dryness and maintain skin elasticity by adding skin-care ingredients, such as superfatting agents, moisturizing agents, and plant extracts. For the moisturizing agents usually used in solid soaps, there are glycerine, propylene glycol, sorbitol, natural oil, and so forth. They form a thin film on the dry skin to prevent evaporation of moisture and protect the skin.

However, effects of these skin-care ingredients are only temporary, and they have no physiological effect on the skin. Also, if their contents are large, physical properties of the soap worsen, and some of the skin-care ingredients are very expensive. To be specific, the conventional skin-care ingredients do not adsorb external moisture to the skin, but just form a temporary protection film on the skin. Because the film is easily removed from the skin, a long-term effect cannot be expected. If contents of the ingredients are increased for a prolonged effect, the soap is readily hydrated by water and it softens.

In order to solve this problem, soap manufactures have focused on introducing surfactants, which have good moisturizing effect and little skin irritation, to the general fatty acid soap as a supplementary cleansing ingredient.

For example, U.S. Pat. Nos. 4,695,395 and 4,663,070 disclose a complex soap with improved skin protection ability by including acyl isethionate, an anionic surfactant, in a solid soap. A complex soap is a soap comprising a fatty acid-based soap as a main cleansing ingredient, and an anionic surfactant as a supplementary cleansing ingredient. Acyl isethionate, the anionic surfactant, is less liquid than the fatty acid-based soap, and it is highly hydrophilic. Therefore, it is less skin-irritable and has good moisturizing ability. However, because it readily absorbs water due to the high solubility, physical properties of the soap worsen.

To solve the problems of the fatty acid-based soap and the complex soap, synthesized solid toilet soap with an increased surfactant content has been developed. The surfactant used in the synthesized solid toilet soap determines the cleansing effect and foamability of the soap. In general, acyl isethionate, alkyl sulfate, alkyl sulfosuccinate, alkyl glyceryl ether sulfonate, linear alkylbenzene sulfonate, acyl taurate, alkyl sulfoacetate, acyl sacosinate, acyl glutamate, alkyl ether sulfate, and so forth are used for the surfactant of synthesized solid toilet soap. Conventionally, the surfactant is comprised at from 30 to 70 parts by weight. More than two to three kinds of surfactants may be used together considering their properties.

The synthesized solid toilet soap also comprises a binder (plasticizer) to improve soap manufacturing workability by offering binding ability and plasticity to the soap, and to improve soap qualities including hardness, softness, foamability, smoothness, and feeling. Conventionally, the binder (plasticizer) is comprised from 10 to 40 parts by weight.

The synthesized solid toilet soap also comprises an excipient and moisture. Their contents are from 0 to 20 parts by weight and from 5 to 15 parts by weight, respectively. They are used to offer structural stability and hardness to the soap. Another reason for using them is that they are more economical than the surfactants. If an excess of the excipient is used in the synthesized solid toilet soap, the soap surface becomes rough, or the soap may crumble.

In addition, a small amount of additives may be added to improve aestheticity of the synthesized solid toilet soap or to offer special properties to it. For example, pigments, perfumes, germicides, and anti-oxidants may be added. Usually, these additives are used in small amounts.

As described above, the conventional synthesized solid toilet soap comprises 30 to 70 parts by weight of a surfactant, 10 to 40 parts by weight of a binder (plasticizer), 0 to 20 parts by weight of the excipient, 5 to 15 parts by weight of moisture, and other additives, and is manufactured by the conventional fatty acid soft soap manufacturing units.

Although dependent on the kind and content of surfactants used as a cleansing ingredient, the synthesized solid toilet soap generally has better feeling and foamability in hard water than the fatty acid soft soap, and particularly, it causes little skin irritation or trouble. However, the synthesized solid toilet soap does not have binding ability and hardness comparable to that of the general fatty acid soft soap. As a result, soap manufacturing is difficult due to poor molding and stamping workability. Also, because it has higher solubility than the fatty acid soap, it readily absorbs water or becomes readily hydrated during or after use, so that it softens easily. Therefore, it looks ugly and offers a bad feeling when using the soap the next time. Also, the fast dissolution of the soap is an economical disadvantage.

To improve the workability and physical properties of the conventional fatty acid soap and the synthesized solid toilet soap while maintaining their advantages, a method of mixing a binder (plasticizer) or an excipient with a surfactant has been proposed. However, if the surfactant content becomes large, the workability, hardness, and physical properties after water absorption worsen. Also, if content of the binder (plasticizer) or the excipient becomes large, the foamability and soap surface feeling, the basic properties of a soap, become poor despite the improvement in soap manufacturing workability, hardness, and softness. Also, cracks may form on the soap after manufacturing or after use.

Salt is widely used for many things, from foods, preservatives, and antiseptics, to medicines, such as a physiological salt solution and Ringer's solution. Traditionally, it has been known to have a variety of advantages to skin. In particular, the Bongam Boncho states that salt “disinfects and treats skin disease, and moisturizes dry skin”. Also, the Boncho Gangmok staes that “Salt treats skin disease, helps granulation, and protects skin. It disinfects and strengthens skin and treats skin disease. It prevents decay and removes offensive odors. It helps granulation and protects skin”. Considering that human blood is 0.9% salt, salt is an important ingredient of a human body.

Also, salt easily removes waste materials and fats on the skin by osmosis, facilitates blood circulation, relieves itching due to atopic dermatitis, removes foot odor, prevents depilation, removes dandruff, treats athlete's foot, kills bacteria, and has a good cleansing effect.

Salt has been used in a soft soap to improve flowability of the slurry solution during neutralization of the fatty acid by reducing its viscosity, or to harden the soap. That is, conventionally, salt has been used to improve manufacturability or physical properties of the soap, rather than to utilize its benefits described above. And, its content has been below 1%. If the salt content becomes large, i.e. if the salt content exceeds 1%, moisture content of the soap decreases and the soap may crack.

There have been several efforts to offer the skin-care effect of salt to a soft soap. Korea Patent Publication No. 1998-083266 discloses a soft soap comprising gold salt to prevent makeup poisoning, skin dryness, skin wetness, dandruff, and skin disease, and to keep the skin clean. However, this patent uses salt only as part of mixture ingredients. Although Korea Patent Publication No. 1988-000082 claims cleansing and massaging effect by use of salt, the content has not been specified. Also, although Korea Patent Publication Nos. 2001-011585, 2000-037949, 2000-008640, and 2001-068654 disclose a method for preparing a monoglyceride sulfonate complex soap and a soft soap composition having good foamability, it does not mention salt or its advantages.

### SUMMARY OF THE INVENTION

It is an object of the present invention to provide a method for economically and easily preparing monoglyceride sulfonate suitable for an anionic surfactant, which can be used for human body cleansing, using an inexpensive fatty acid.

It is another object of the present invention to provide a cleansing agent for a human body that comprises monoglyceride sulfonate prepared by the method.

Still another object of the present invention is to provide a soft soap composition having superior molding and stamping workability, softness, smoothness, foamability, and moisturizing ability using the monoglyceride sulfonate.

Still another object of the present invention is to provide a method for preparing a soft soap composition comprising a lot of salt using the fatty acid used to prepare the monoglyceride sulfonate.

Still another object of the present invention is to provide a method for conveniently and easily preparing a soft soap composition comprising a lot of salt.

Still another object of the present invention is to provide a method for preparing a soft soap composition comprising a lot of salt, so that it softens skin, easily removes waste materials, prevents skin irritation, promotes blood circulation, and prevents depilation and dandruff when used for a soft soap.

In order to attain these objects, the present invention provides a method for preparing monoglyceride sulfonate represented by the following Chemical Formula 1, which comprises a step of neutralizing a fatty acid obtained from an animal oil such as tallow and lard, or from one or more plant oils selected from a group consisting of coconut oil, lauric acid, palm oil, and palm kernel oil in a solvent to prepare an alkali metal salt of fatty acid, or a mixture thereof, and reacting the same with a compound represented by the following Chemical Formula 2:

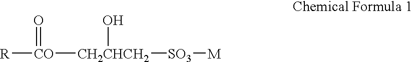

Chemical Formula 2
ClCH₂CH(OH)CH₂SO₃—M

wherein R is a C₇ to C₂₁ saturated or unsaturated aliphatic hydrocarbon radical; and M is sodium, potassium, triethanolamine, or ammonia.

The present invention also provides a cleansing agent for a human body, which comprises monoglyceride sulfonate prepared by the method.

The present invention also provides a soft soap composition, which comprises: 50 to 90 parts by weight of a mixture of monoglyceride sulfonate represented by the following Chemical Formula 1 and a fatty acid soap, with lauric acid and myristic acid contents of over 60wt %; 1 to 12 parts by weight of a fatty acid; and 1 to 25 parts by weight of a binder (plasticizer) or an excipient:

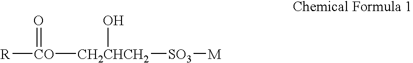

wherein R is a C₇ to C₂₁ alkyl; and M is sodium, potassium, triethanolamine, or ammonia.

The present invention also provides a method for preparing a soft soap containing salt, which comprises:

(a) a step of neutralizing a C₈ to C₂₂ saturated or unsaturated fatty acid with caustic soda to prepare a fatty acid sodium salt represented by the following Chemical Formula 3a; and

(b) a step of reacting the fatty acid sodium salt with 3-chloro-2-hydroxypropanesulfonic acid sodium salt (SCHS) represented by the following Chemical Formula 2a in the presence of a solvent:

Chemical Formula 3a
RCOO—Na

Chemical Formula 2a
ClCH₂CH(OH)CH₂SO₃Na

wherein R is a C₇ to C₂₁ saturated or unsaturated aliphatic hydrocarbon.

### DETAILED DESCRIPTION OF THE PREFERRED EMBODIMENTS

Hereinafter, the present invention is explained in more detail.

The present invention provides a method for preparing monoglyceride inexpensively, that is less irritable to a human body and that has good feeling and moisturizing ability, so that it is useful as a cleansing agent for the human body, from inexpensive fatty acids such as animal oil and plant oil.

Since the monoglyceride sulfonate of the present invention contains an ester group, it is less skin-irritable and has lower solubility than conventional surfactants. This may be due to the hydrogen bond between the hydroxy group and the sulfonate.

The preparing method of monoglyceride sulfonate represented by Chemical Formula 1 according to the present invention is described in more detail.

To prepare the monoglyceride sulfonate, the compound represented by Chemical Formula 2 is prepared. For this purpose, a reducing agent is dissolved in water and epichlorohydrin is added to prepare the intermediate represented by Chemical Formula 2. Preferably, the compound represented by Chemical Formula 2 is sodium chlorohydroxysulfonate. Preferably, the reducing agent is sodium sulfite, sodium bisulfite, or sodium metabisulfite. Contents of the epichlorohydrin and the reducing agent, and reaction conditions, conform to the conventional preparing methods.

Then, the intermediate represented by Chemical Formula 2 is added to the alkali metal salt of a fatty acid or mixture thereof to prepare monoglyceride sulfonate represented by Chemical Formula 1 by substitution esterification.

The alkali metal salt of a fatty acid can be obtained from neutralization of a fatty acid. For the fatty acid, an inexpensive high-quality fatty acid represented by the following Chemical Formula 3, which is derived from an animal oil such as tallow and lard, or a plant oil such as coconut oil, palm oil, and palm kernel oil, can be used:

Chemical Formula 3
RCOOM

In Chemical Formula 3, R is a C₇ to C₂₁ saturated or unsaturated aliphatic hydrocarbon radical; and M is sodium, potassium, triethanolamine, or ammonia.

The fatty acid may be neutralized in 100% equivalents. Otherwise, the neutralization may be carried out in the presence of a free fatty acid. The fatty acid content can be determined depending on its use. If the free fatty acid content exceeds 10 wt %, the reaction tends to proceed slowly, so less than 10 wt % of fatty acid content is preferred.

Preferably, the substitution esterification is carried out in water or in a solvent mixture of water and a low alcohol. For the alcohol, there are methanol, ethanol, propanol, and so forth. Among these, ethanol is the most preferable. Preferably, the alcohol is used at from 20 to 70 wt %, and more preferably from 40 to 60 wt % for 100 wt % of water.

Preferably, the equivalent ratio of the alkali metal salt of fatty acid and the compound represented by Chemical Formula 2 is 1:0.05 to 1.2.

Preferably, the content of the reactants is 50 to 95 wt %, and more preferably from 60 to 80 wt %, for 100 wt % of the solvent.

Preferably, the reaction temperature is from 80 to 135° C., and more preferably, from 95 to 125° C. After the reaction is completed, drying is carried out by the general drying method, such as spraying, drum drying, and convection drying, to obtain the final product.

The obtained final product comprises monoglyceride sulfonate, a fatty acid alkali metal salt, a fatty acid, sodium chlorohydroxy sulfonate represented by Chemical Formula 2, sodium dihydroxy sulfonate salt, and salt. Composition of the ingredients monoglyceride sulfonate (A), fatty acid alkali metal salt (B), fatty acid (C), sodium chlorohydroxy sulfonate (D), sodium dihydroxy sulfonate (E), and salt (F) of the final product are: A/B/C/D+E/F=from 1/0.15/0.07/0.12/0.18 to 1/22/1.2/0.25/0.25 by weight.

The content of the monoglyceride sulfonate is determined by the equivalent ratio of the compound represented by Chemical Formula 2 (preferably, sodium chlorohydroxy sulfonate salt), which is used as an alkalizing agent of the fatty acid alkali metal salt. The content can be controlled depending on use of the cleansing agent.

The present invention also may provide a cleansing agent for a human body comprising monoglyceride sulfonate prepared by the above method as an anionic surfactant.

For the cleansing agent for a human body, there are soap and body shampoo, but the present invention is not limited by such examples. The final product can be directly put into a soap manufacturing unit to prepare a soap having superior moisturizing ability and skin-care effects, and a body shampoo made from the final product has superior foamability and skin moisturizing effects.

The content of each ingredient of the final product used for a cleansing agent for a human body can be determined by the manufacturing method, type and property, pH, packaging, storing method, and prescription content of each product.

Hereinafter, a more specific description of a soft soap composition of the present invention is given.

To overcome the problems of the conventional fatty acid soaps, complex soaps, and synthesized solid toilet soaps, the present invention provides a soft soap composition that comprises monoglyceride sulfonate containing more than 60 wt % of lauric acid and myristic acid, and a fatty acid soap as a main cleansing ingredient rather than the conventional surfactants, and a fatty acid as a binder. As a result, a solid soap made from the soft soap composition of the present invention has good moldability, stamping workability, softness, smoothness, foamability, and moisturizing ability.

The soft soap composition of the present invention comprises monoglyceride sulfonate represented by Chemical Formula 1. Preferably, the soft soap composition of the present invention comprises a mixture of monoglyceride sulfonate represented by Chemical Formula 1, whose lauric acid (C₁₂) and myristic acid (C₁₄) content is over 60 wt %, and preferably over 70 wt %, and a fatty acid soap as a main cleansing ingredient. If the content of lauric acid and myristic acid is below 60 wt %, too much unsaturated fatty acid (oleic acid or linoleic acid) or long chain fatty acid (palmitic acid or stearic acid) is contained. If there is too much unsaturated fatty acid in the monoglyceride sulfonate, the melting point decreases, and the solubility increases, so that the moldability and the stamping workability become poor and the softness worsens. If there is too much long chain fatty acid in the monoglyceride sulfonate, the melting point becomes so high that the soap may crack during stamping due to insufficient plasticity and binding ability, or the foamability and the smoothness of the soft soap become poor. These problems are aggravated when the content of the monoglyceride sulfonate is larger than that of the fatty acid soap in the cleansing ingredient.

The preparing method of the monoglyceride sulfonate is not particularly limited. As described above, fatty acid obtained from an animal oil such as tallow and lard, or from a plant oil such as coconut oil, palm kernel oil, palm oil, and palm stearin, or lauric acid, myristic acid, and stearic acid, obtained by separation distillating the fatty acid and hydrogenating it, can be used.

For the fatty acid soap used as a main cleansing ingredient along with the monoglyceride sulfonate, the fatty acid used to prepare the monoglyceride sulfonate, that is, fatty acid obtained from an animal oil, such as tallow and lard, or from a plant oil, such as coconut oil, palm kernel oil, palm oil and palm stearin, which has been neutralized with caustic soda, caustic alkali, or triethanolamine, can be used alone or in combination. Also, lauric acid, myristic acid, and stearic acid obtained by separation distillating the fatty acid and hydrogenating it can be used to prepare the fatty acid soap. The alkyl composition of the fatty acid soap can be determined considering the basic properties of the solid soap and economics.

The main cleansing ingredient of the present invention, that is the monoglyceride sulfonate and the fatty acid soap, is used when mixed in the ratio of from 1:0.3 to 0.03:1. Preferably, it is used at 50 to 90 parts by weight. Within this range, the binding ability and the solubility of the soap are appropriate to improve softness of the soap. Also, the soap foamability can be improved by the interaction of monoglyceride sulfonate and fatty acid soap, and the moisturizing ability becomes superior. If the content of the main cleansing ingredient is below 50 parts by weight, the soap foamability and feeling become poor. Otherwise, if it exceeds 90 parts by weight, the soap becomes rigid in spite of adding a binder (plasticizer) or moisture, so that it cracks during stamping, and it is difficult to make it into a solid soap.

The soft soap composition of the present invention comprises fatty acid as a binder to improve the moldability and the stamping workability of the soap by offering appropriate plasticity and to improve smoothness. For the fatty acid, the fatty acid used for preparing the monoglyceride sulfonate, that is, fatty acid obtained from an animal oil, such as tallow and lard, or from a plant oil, such as coconut oil, palm kernel oil, palm oil and palm stearin, may be used alone or in combination. Of course, lauric acid, myristic acid, and stearic acid obtained by separation distillating a fatty acid and hydrogenating it can be used. The alkyl composition of the fatty acid can be determined considering the basic property of the solid soap and economics.

Preferably, the fatty acid is used at from 1 to 12 parts by weight. If the fatty acid content is below 1 part by weight, the plasticity and the binding ability becomes poor, so that the moldability, the stamping workability, and the softness worsen. Otherwise, if it exceeds 12 parts by weight, shaping of the solid soap becomes difficult and the smoothness becomes poor due to the viscosity of the fatty acid and its low melting point.

The soft soap composition of the present invention comprises 1 to 25 parts by weight of a binder (plasticizer) or an excipient. The binder (plasticizer) improves soap manufacturing workability by offering binding ability and plasticity to the soap, and improves softness, foamability, and smoothness (feeling) of the manufactured soap. For the binder (plasticizer), the conventional long chain fatty alcohol, long chain fatty acid, hardened fat, paraffin wax, polyester, polyethylene glycol, sodium stearate, hardened caster oil, fatty alkyl ketone, and so forth can be used.

The soap shaper maintains structural stability or hardness of the soap. For the soap shaper, the conventional dextrin, starch, sodium sulfate, salt, talc, and so forth can be used.

The soft soap composition of the present invention may comprise 1 to 25 parts by weight of a surfactant, which is used in the conventional synthesized solid toilet soaps, as a supplementary cleansing ingredient, within a range not affecting the effect of the present invention. Also, it may comprise a small amount of additives, such as pigment, perfume, germicide, anti-oxidant, and metal ion inhibitor, to improve aestheticity of the soap or to offer a special property.

The present invention also provides a soft soap containing salt using the fatty acid used in preparing the monoglyceride sulfonate represented by Chemical Formula 1.

The present invention prepares the soft soap containing salt by reacting fatty acid sodium salt represented by Chemical Formula 3 with a sodium compound represented by Chemical Formula 2.

To be specific, the present invention comprises: (a) a step of preparing a fatty acid sodium salt represented by Chemical Formula 3a by neutralizing a fatty acid with caustic soda; and (b) a step of reacting the neutralized compound with 3-chloro-2-hydroxypropanesulfonic acid sodium salt (SCHS) represented by Chemical Formula 2a in a solvent.

Chemical Formula 3a
RCOONa

In Chemical Formula 3a, R is a C₇ to C₂₁ saturated or unsaturated aliphatic hydrocarbon.

Chemical Formula 2a
RCOOCH₂CH(OH)CH₂SO₃Na

In the step (a), the fatty acid may be a C₈ to C₂₂ saturated or unsaturated fatty acid, and the fatty acid may be a single fatty acid or a mixture of fatty acids. For a preferred example, the fatty acid may be an inexpensive long chain fatty acid derived from the animal oil or the plant oil used for preparing the monoglyceride sulfate.

In the step (a), the neutralization of the fatty acid may be carried out using caustic soda in a 100% equivalent ratio. Even if there is free fatty acid, a post-reaction is possible.

In the step (b), the compound represented by Chemical Formula 2a may be prepared by dissolving a reducing agent in water, and adding epichlorohydrin. The reducing agent may be selected from a group consisting of sodium sulfite, sodium bisulfite, sodium metabisulfite, and any mixture thereof. Preferably, the contents of epichlorohydrin and the reducing agent, and the reaction conditions, conform to the conventional methods.

In the step (b), the fatty acid sodium salt represented by Chemical Formula 3a is reacted with 3-chloro-2-hydroxypropanesulfonic acid sodium salt to prepare a salt by substitution esterification. The reaction is controlled by the equivalent ratio of the two components, although variable depending on the kind of the fatty acid and the degree of neutralization. Preferably, the equivalent ratio of the fatty acid sodium salt represented by Chemical Formula 3a to the 3-chloro-2-hydroxypropanesulfonic acid sodium salt represented by Chemical Formula 2a is from 1:0.1 to 1:1.2. The higher the content of the 3-chloro-2-hydroxypropanesulfonic acid sodium salt, the more salt is obtained, about from 2 to 15 wt %,. However, if the equivalent ratio is below 1:0.1, the salt content becomes less than 2%, so that the skin-care effect becomes insignificant. Otherwise, if it exceeds 1:1.2, excessive salt formation may cause eduction of salt out of the soap or cracking of the soap.

The solvent used in the step (b) may be a conventional solvent. Preferably, a solvent selected from a group consisting of water, methanol, ethanol, propanol, and any mixture thereof is used. Preferably, the reaction temperature is from 80 to 135° C., and more preferably, from 95 to 125° C. After the reaction is completed, drying is carried out to obtain the final product. The drying can be performed by the conventional drying method, such as spraying, drum drying, and convention drying.

Also, in the step (b), monoglyceride sulfonate represented by Chemical Formula 1, a free fatty acid, soap content, and unreacted 3-chloro-2-hydroxypropanesulfonic acid sodium salt may be obtained, in addition to salt, depending on the situation.

The method for preparing a soft soap containing salt according to the present invention may further comprise a step of adding compositions added in the conventional soft soaps.

As described above, the present invention provides a simple and effective preparing method of a soft soap containing salt. The soft soap prepared by the present invention contains from 2 to 15 wt % of salt, so that it softens the skin, easily removes waste materials, prevents irritation, promotes blood circulation, prevents depilation and dandruff, and offers superior skin-care effects.

Hereinafter, the present invention is described in more detail through Examples and Comparative Examples. However, the following Examples are only for the understanding of the present invention, and the present invention is not limited by the following Examples.

### EXAMPLES

### Preparing Example 1

Sodium sulfite was dissolved in water, and epichlorohydrin was added to prepare a sodium chlorohydroxy sulfonate powder.

### Example 1

220 g of palm kernel oil fatty acid was dissolved in 90 g of ethanol in an autoclave reactor. Then, 80 g of a 50% sodium hydroxide solution was added dropwise to neutralize the fatty acid and to obtain a palm kernel oil fatty acid sodium salt. The reactor was stirred for 30 minutes while keeping the temperature inside the reactor at 75° C. Then, 196.6 g of the sodium chlorohydroxy sulfonate powder obtained in Preparing Example 1 was added to the reactor. After closing the reactor, the reactor was heated so that its internal temperature reached 120° C. Then, reaction was carried out for 1 hour and 30 minutes until the content of monoglyceride sulfonate measured by anion quantitative analysis reached the maximum. After the reaction was completed, the reaction solution was dried in a convection oven to obtain 440 g of an anionic surfactant, with a monoglyceride sulfonate content of 63%.

The composition of the monoglyceride was determined as follows. The anionic surfactant was titrated using methylene blue as an indicator. The end point was when both the chloroform layer and the water layer turn blue. The content was determined by the following Equation 1:

$$Content ( \% ) = \frac{( B - A ) \times 0.004 \times f \times MW}{S \times 10} \times 100 \qquad [ Equation 1 ]$$

in Equation 1,

A is the amount of cationic surfactant standard solution (ml) consumed during blank titration;

B is the amount of cationic surfactant standard solution (ml) consumed during sample solution titration;

f is the factor of cationic surfactant standard solution;

S is the amount of the sample (g); and

MW is the molecular weight of monoglyceride sulfonate.

### Example 2

200 g of palm kernel oil fatty acid was dissolved in 56 g of ethanol in an autoclave reactor. Then, 80 g of 50% sodium hydroxide solution was added dropwise to neutralize the fatty acid and to obtain a palm kernel oil fatty acid sodium salt. The reactor was stirred for 30 minutes keeping the temperature inside the reactor at 75° C. Then, 98.3 g of the sodium chlorohydroxy sulfonate powder obtained in Preparing Example 1 was added to the reactor. After closing the reactor, the reactor was heated so that its internal temperature reached 120° C. Then, reaction was carried out for 1 hour until the content of monoglyceride sulfonate measured by anion quantitative analysis reached the maximum. After the reaction was completed, the reaction solution was dried in a convection oven to obtain 320 g of an anionic surfactant composition, with a monoglyceride sulfonate content of 35%.

### Example 3

22 Kg of palm kernel oil fatty acid, and 20 Kg of lauric acid were dissolved in 13.5 Kg of ethanol in a 400L Sus reactor. Then, 16 Kg of 50% sodium hydroxide solution was added dropwise to neutralize the fatty acid and to obtain a fatty acid sodium salt. The reactor was stirred for 30 minutes keeping the temperature inside the reactor at 75° C. Then, 27.5 Kg of the sodium chlorohydroxy sulfonate powder obtained in Preparing Example 1 was added to the reactor. After closing the reactor, the reactor was heated so that its internal temperature reached 120° C. Then, reaction was carried out for 2 hours until the content of monoglyceride sulfonate measured by anion quantitative analysis reached the maximum. After the reaction was completed, the reaction solution was dried in a convection oven to obtain 72 Kg of an anionic surfactant composition, with a monoglyceride sulfonate content of 54%.

### Example 4

22 Kg of palm kernel oil fatty acid, and 20 Kg of lauric acid were dissolved in 13.5 Kg of ethanol in a 400L Sus reactor. Then, 16 Kg of 50% sodium hydroxide solution was added dropwise to neutralize the fatty acid and to obtain a fatty acid sodium salt. The reactor was stirred for 30 minutes while keeping the temperature inside the reactor at 75° C., then 3.9 Kg of the sodium chlorohydroxy sulfonate powder was added to the reactor. After closing the reactor, the reactor was heated so that its internal temperature reached 120° C., and the reaction was carried out for 2 hours until the content of monoglyceride sulfonate measured by anion quantitative analysis reached the maximum. After the reaction was completed, the reaction solution was dried in a convection oven to obtain 51 Kg of an anionic surfactant composition, with a monoglyceride sulfonate content of 10.5%.

### Examples 5-8 and Comparative Examples 1-6

Compositions having the components and contents shown in Table 1 were uniformly mixed in an amalgamator and a three-layer roll mill. Then, soaps were prepared by molding, extruding, and shaping using the conventional fatty acid soft soap manufacturing unit.

TABLE 1
(Unit: parts by weight)

| | Examples | | | | Comparative Examples | | | | | |
|---|---|---|---|---|---|---|---|---|---|---|
| | 1 | 2 | 3 | 4 | 1 | 2 | 3 | 4 | 5 | 6 |
| Sodium | 3.0 | 6.0 | — | — | — | — | — | — | 19.7 | — |
| monoglyceride | | | | | | | | | | |
| sulfonate (I)^{a} | | | | | | | | | | |
| Sodium | — | — | 15.0 | 25.0 | — | — | — | — | — | — |
| monoglyceride | | | | | | | | | | |
| sulfonate (II)^{b} | | | | | | | | | | |
| Sodium | — | — | — | — | 5.0 | 15.0 | — | — | — | — |
| monoglyceride | | | | | | | | | | |
| sulfonate (III)^{c} | | | | | | | | | | |
| Sodium cocoyl | — | — | — | 5.0 | — | — | — | — | — | 15.0 |
| isethionate | | | | | | | | | | |
| Sodium | 77.7 | 73.7 | 63.7 | 45.7 | 78.0 | 64.0 | 83.0 | 81.0 | 64.0 | 65.0 |
| palmate/ | | | | | | | | | | |
| palm | | | | | | | | | | |
| kernelate | | | | | | | | | | |
| soap | | | | | | | | | | |
| Sorbitol | — | — | — | — | — | — | 3.0 | — | — | — |
| Palm kernel | 5.0 | 5.0 | 5.0 | 5.0 | 1.7 | 4.7 | — | 5.0 | — | 5.0 |
| fatty acid | | | | | | | | | | |
| Sodium | — | — | — | 3.0 | — | — | — | — | — | 1.0 |
| isethionate | | | | | | | | | | |
| Salt | 1.0 | 2.0 | 3.0 | 3.0 | 2.0 | 3.0 | 0.7 | 0.7 | 3.0 | 0.7 |
| Moisture | 12.0 | 12.0 | 12.0 | 12.0 | 12.0 | 12.0 | 12.0 | 12.0 | 12.0 | 12.0 |
| Titanium | 0.3 | 0.3 | 0.3 | 0.3 | 0.3 | 0.3 | 0.3 | 0.3 | 0.3 | 0.3 |
| dioxide | | | | | | | | | | |
| Perfume | 1.0 | 1.0 | 1.0 | 1.0 | 1.0 | 1.0 | 1.0 | 1.0 | 1.0 | 1.0 |

Note)
Alkyl contents of sodium monoglyceride sulfonate
^{a}Sodium monoglyceride sulfonate (I): Prepared using cocoyl fatty acid only (content of lauric acid and myristic acid = 63 wt %)
^{b}Sodium monoglyceride sulfonate (II): Prepared using cocoyl fatty acid and lauric acid at 70:30 (content of lauric acid and myristic acid = 74 wt %)
^{c}Sodium monoglyceride sulfonate (III): Prepared using cocoyl fatty acid

and palm oil fatty acid at 50:50 (content of lauric acid and myristic acid=32 wt %)

### Examples 9-12 and Comparative Examples 7-12

Compositions having the components and contents shown in Table 2 were uniformly mixed in an amalgamator and a three-layer roll mill. Then, soaps were prepared by molding, extruding, and shaping using the conventional fatty acid soft soap manufacturing unit.

TABLE 2
(Unit: parts by weight)

| | Examples | | | | Comparative Examples | | | | | |
|---|---|---|---|---|---|---|---|---|---|---|
| | 5 | 6 | 7 | 8 | 7 | 8 | 9 | 10 | 11 | 12 |
| Sodium | 60.0 | 40.0 | 20.0 | — | 20.0 | — | — | — | — | — |
| monoglyceride | | | | | | | | | | |
| sulfonate (IV)^{d} | | | | | | | | | | |
| Sodium | — | — | 40.0 | 33.0 | — | 33.0 | — | — | — | 50.0 |
| monoglyceride | | | | | | | | | | |
| sulfonate (V)^{e} | | | | | | | | | | |
| Sodium | — | — | — | — | — | — | 50.0 | — | — | — |
| monoglyceride | | | | | | | | | | |
| sulfonate (VI)^{f} | | | | | | | | | | |
| Sodium | — | — | — | — | — | — | — | 30.0 | — | — |
| monoglyceride | | | | | | | | | | |
| sulfonate | | | | | | | | | | |
| (VII)^{g} | | | | | | | | | | |
| Sodium cocoyl | — | 5.0 | — | — | — | 7.7 | — | — | 48.0 | — |
| isethionate | | | | | | | | | | |
| Sodium lauryl | — | — | — | 5.0 | — | — | — | 30.0 | 10.0 | 20.0 |
| sulfate | | | | | | | | | | |
| Sodium | 6.0 | 32.7 | 16.7 | 33.0 | 67.0 | 13.0 | 26.0 | 20.0 | 10.0 | — |
| palmate/ | | | | | | | | | | |
| palm | | | | | | | | | | |
| kernelate | | | | | | | | | | |
| soap | | | | | | | | | | |
| Stearic acid | 3.0 | — | 2.0 | 5.0 | — | 15.0 | — | 2.0 | 12.0 | 7.7 |
| Palm kernel | 7.0 | 7.0 | 5.0 | 3.7 | 0.5 | 3.0 | 2.7 | 2.7 | 3.0 | 3.0 |
| fatty acid | | | | | | | | | | |
| Polyethylene | 5.0 | — | — | 4.0 | — | 15.0 | 4.0 | 2.0 | 2.7 | 1.0 |
| glycol (EO | | | | | | | | | | |
| addition: 75 mol) | | | | | | | | | | |
| Salt | 9.7 | 6.0 | 8.0 | 4.0 | 3.0 | 4.0 | 8.0 | 2.0 | 1.0 | 7.0 |
| Moisture | 8.0 | 8.0 | 7.0 | 11.0 | 8.2 | 8.0 | 8.0 | 10.0 | 12.0 | 10.0 |
| Titanium | 0.3 | 0.3 | 0.3 | 0.3 | 0.3 | 0.3 | 0.3 | 0.3 | 0.3 | 0.3 |
| dioxide | | | | | | | | | | |
| Perfume | 1.0 | 1.0 | 1.0 | 1.0 | 1.0 | 1.0 | 1.0 | 1.0 | 1.0 | 1.0 |

Note)
Alkyl contents of sodium monoglyceride sulfonate
^{d}Sodium monoglyceride sulfonate (IV): Prepared using cocoyl fatty acid and myristic acid at 50:50 (content of lauric acid and myristic acid = 81 wt %)
^{e}Sodium monoglyceride sulfonate (V): Prepared using lauric acid and stearic acid at 80:20 (content of lauric acid and myristic acid = 80 wt %)
^{f}Sodium monoglyceride sulfonate (VI): Prepared using lauric acid and stearic acid at 20:80 (content of lauric acid and myristic acid = 20 wt %)
^{g}Sodium monoglyceride sulfonate (VII): Prepared using lauric acid and stearic acid at 50:50 (content of lauric acid and myristic acid = 50 wt %)

The workability, softness, foamability, smoothness (feeling), and moisturizing ability of the soft soaps prepared in Examples 1-8 and Comparative Examples 1-12 were tested as follows.

(1) Molding and Stamping Workability

Molding workability was determined from transfer status in a molder and a screw when manufacturing the soap with a conventional fatty acid soft soap manufacturing unit. Stamping workability was determined by the ease at which the soap is extricated from the mold. The evaluation standard was as follows:

<Evaluation Standard>

◯: Superior molding and stamping workability.

Δ: Moderate molding and stamping workability.

X: Poor molding and stamping workability due to excessive hardness or softness of the soap.

(2) Softness

Softness of the soap was determined from its water absorptivity. A weighed soap (W₁) stuck with a weighed pin (W₂) was put in a 25° C. water bath for 4 hours. Then, the eluted soap was dried at 20-25° C. for 1 hour, and then weighed (W₃). The water absorptivity was calculated from the following Equation 2.
Water absorptivity (%)=[(W₂+W₃)−(W₁+W₂)]/W₁×100 [Equation 2]

The higher the water absorptivity, the more water the soap contains, thereby worsening physical properties of the soap. Typically, water absorptivity of the conventional fatty acid soft soap is from 5 to 25%.

(3) Foamability and Smoothness

20 men and 20 women were given the synthesized solid toilet soaps prepared in Examples and Comparative Examples. They used the soap with 25° C. tap water and rated foamability and smoothness of the soap according to the standard shown in the following Table 3. The ratings were averaged.

TABLE 3

| | Foamability | Smoothness |
|---|---|---|
| 5 points | Large and much foam | Very smooth |
| 4 points | Slightly large and much foam | Slightly smooth |
| 3 points | Moderately large and much foam | Moderate |
| 2 points | Slightly small and little foam | Slightly rough |
| 1 point | Very small and little foam | Very rough |

Typically, foamability and smoothness of fatty acid soft soaps are over 3.0 points.

(4) Moisturizing Ability

Moisturizing ability was determined from the moisture content. Soft soap compositions having compositions of Examples and Comparative Examples were diluted with distilled water to 4% aqueous solutions. A 5 cm×5 cm area of an inner arm was rubbed with 5 ml of the aqueous solution. After 30 seconds, the arm was washed with flowing water for 10 seconds. The arm was washed twice with 3-hour interval. After 30 minutes, the moisture content was determined. The moisture content was determined with Skicon 200 under the condition of 25° C. and R.H. 50%. The moisture content was calculated by the following Equation 3. The higher the moisture content, the more superior the moisturizing ability.
Moisture content (%)=[(Moisture before washing−Moisture after washing)/Moisture before washing]×100 Equation 3

The results are shown in the following Table 4 and Table 5.

TABLE 4

| | | Examples | | | | Comparative Examples | | | | | |
|---|---|---|---|---|---|---|---|---|---|---|---|
| | | 1 | 2 | 3 | 4 | 1 | 2 | 3 | 4 | 5 | 6 |
| Workability | Molding & | ◯ | ◯ | ◯ | ◯ | Δ | Δ | Δ | ◯ | Δ | ◯ |
| | stamping | | | | | | | | | | |
| | workability | | | | | | | | | | |
| Physical | Water | 15.0 | 17.6 | 20.0 | 23.0 | 20.1 | 25.0 | 27.0 | 15.3 | 26.0 | 30.5 |
| properties | absorptivity | | | | | | | | | | |
| | (%) | | | | | | | | | | |
| | Foamability | 3.5 | 4.0 | 4.0 | 4.5 | 2.5 | 2.5 | 3.5 | 4.0 | 4.0 | 3.5 |
| | Smoothness | 4.0 | 4.0 | 4.5 | 4.5 | 3.5 | 3.0 | 4.0 | 4.0 | 3.5 | 4.0 |
| | Moisture | 57.5 | 58.1 | 61.6 | 65.6 | — | — | 45.0 | 51.1 | 60.0 | — |
| | content (%) | | | | | | | | | | |
| | (Measurement¹⁾ | | | | | | | | | | |
| | Moisture | 53.1 | 54.0 | 59.6 | 60.6 | — | — | 39.1 | 44.5 | 55.5 | — |
| | content (%) | | | | | | | | | | |
| | (Measurement²⁾ | | | | | | | | | | |

TABLE 5

| | | Examples | | | | Comparative Examples | | | | | |
|---|---|---|---|---|---|---|---|---|---|---|---|
| | | 5 | 6 | 7 | 8 | 7 | 8 | 9 | 10 | 11 | 12 |
| Workability | Molding & | ◯ | ◯ | ◯ | ◯ | X | Δ | ◯ | X | Δ | Δ |
| | stamping | | | | | | | | | | |
| | workability | | | | | | | | | | |
| Physical | Water | 11.5 | 15.0 | 12.5 | 8.0 | — | −10.0 | 21.0 | — | 27.0 | 30.5 |
| properties | absorptivity | | | | | | | | | | |
| | (%) | | | | | | | | | | |
| | Foamability | 3.5 | 4.5 | 4.0 | 4.5 | — | 2.0 | 1.5 | — | 4.0 | 4.0 |
| | Smoothness | 3.5 | 4.5 | 4.0 | 4.0 | — | 2.0 | 1.5 | — | 3.5 | 2.0 |
| | Moisture | 65.5 | 62.2 | 63.6 | 66.5 | — | — | — | — | 59.6 | — |
| | content (%) | | | | | | | | | | |
| | (Measurement¹⁾ | | | | | | | | | | |
| | Moisture | 63.1 | 57.6 | 59.8 | 61.1 | — | — | — | — | 56.8 | — |
| | content (%) | | | | | | | | | | |
| | (Measurement²⁾ | | | | | | | | | | |

Note)
“—” means that measurement was impossible because the soap status was not maintained.

From the results shown in Table 4 and Table 5, it is apparent that the soft soap of the present invention, which comprises 50 to 90 parts by weight of a mixture of monoglyceride sulfonate, containing more than 60 wt % of lauric acid and myristic acid, and a fatty acid soap as a main cleansing ingredient, and a fatty acid as a binder, has superior molding and stamping workability, softness, foamability, smoothness, and moisturizing ability. On the contrary, if the lauric acid and myristic acid content is below 60 wt %, the molding and stamping workability becomes poor (Comparative Examples 1, 2, and 10), or foamability and smoothness become poor (Comparative Example 9).

Also, if the content of monoglyceride sulfonate and fatty acid soap is below 50 parts by weight, softness, foamability, and smoothness become poor (Comparative Examples 5, 7, 8, and 12), and the content of monoglyceride and moisture is limited, thereby causing cracking during stamping.

### Examples 8 to 13 and Comparative Examples 13 and 14

Lauric acid and palm kernel oil fatty acid were mixed in a ratio of 70:30. Then, caustic soda was added dropwise in a solvent of water and ethanol to completely neutralize the fatty acid and to obtain a sodium salt of lauric acid and palm kernel oil fatty acid. Then, 3-chloro-2-hydroxypropanesulfonic acid sodium salt (SCHS) was added at an elevated temperature to obtain a mixture solution of salt, monoglyceride sulfonate, free fatty acid, and soap ingredients. The mixture solution was dried at a high temperature and high pressure, and additives were added. Then, a soft soap was prepared through molding and stamping.

### Test Example 1: Salt Content Analysis

Salt content of the soft soaps prepared in Examples 8 to 13 and Comparative Examples 13 to 14 was determined by KSM 2702. The results 5 are shown in the following Table 6.

TABLE 6

| | Molar ratio | |
|---|---|---|
| | (of SCHS and fatty | |
| | acid sodium salt) | Salt content (%) |
| Example 8 | 0.1:1 | 2.2 |
| Example 9 | 0.3:1 | 6.0 |
| Example 10 | 0.5:1 | 8.9 |
| Example 11 | 0.7:1 | 11.2 |
| Example 12 | 0.9:1 | 13.3 |
| Example 13 | 1.2:1 | 14.8 |
| Comp. Example 13 | 0.05:1 | 0.8 |
| Comp. Example 14 | 1.5:1 | 17.2 |

Fatty acid prepared from lauric acid and palm kernel oil fatty acid (70:30)
Fatty acid 100% neutralized with caustic soda

As seen in Table 6, the salt contents of the soft soaps prepared in Examples 8 to 13 are from 2 to 15%. Therefore, it is apparent that an adequate molar ratio of 3-chloro-2-hydroxypropanesulfonic acid sodium salt and fatty acid sodium salt is from 0.1:1 to 1.2:1. On the other hand, the soft soap prepared in Comparative Example 13 had too little salt, and the soft soap prepared in Comparative Example 14 had too much salt.

### Test Example 2: Quality Analysis

Quality of the soft soaps prepared in Example 10 and Comparative Example 13 was evaluated.

50 men and women of ages 18 to 50 were selected. Quality evaluation was performed regarding skin softness, removal of waste materials, scalp condition, and skin irritation.

The subjects were grouped in two groups of 25 people. One group was given the soft soap prepared in Example 10, and the other was given the soft soap prepared in Comparative Example 13. One week later, they exchanged the soft soaps. For the two weeks, the subjects were not allowed to use any other cleansing agents. They used the soft soaps for the whole body, including head and face. Two weeks later, the subjects evaluated quality of the soft soaps according to the following standard. The results are shown in the following Table 7.

TABLE 7

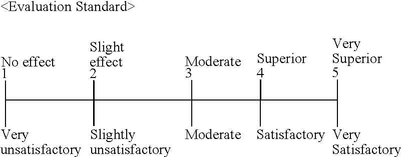

| | | | Scalp | | |
|---|---|---|---|---|---|
| | | Removal | condition | | |
| Classifi- | Skin | of waste | (dandruff/ | Skin | Overall |
| cation | Softness | materials | irritation) | irritation | satisfaction |
| Example 3 | 3.98 | 3.85 | 3.55 | 4.02 | 3.85 |
| Comp. | 3.30 | 3.26 | 3.25 | 3.88 | 3.40 |
| Example 1 | | | | | |

From Table 7, it is apparent that the soft soap prepared in Example 10, which contains a lot of salt, offers superior softness, removal of waste materials, and skin condition enhancement, and less skin irritation.

As described above, the method for preparing monoglyceride sulfate of the present invention is economical because monoglyceride sulfonate useful for cleansing agents for a human body can be prepared in a large amount from an inexpensive fatty acid using a convenient manufacturing unit. Also, the monoglyceride sulfonate prepared by the present invention has superior biodegradability, foamability, and rinsing ability, compared to the conventional anionic surfactants. Also, it is less irritable to a human body, and has superior feeling and moisturizing ability. Therefore, it is suitable for human body cleansers. That is, it is less skin-irritable because it is neutral in aqueous solution, less soluble in water, and fairly stable in hard water. Therefore, it can be made into solid, liquefied, or dispersing cleansers.

Also, the soft soap composition of the present invention has superior molding and stamping workability, softness, smoothness, foamability, and moisturizing ability because it comprises monoglyceride sulfonate and a fatty acid soap containing more than 60wt% of lauric acid and myristic acid, as a main cleansing ingredient.

Also, the present invention provides a method for preparing a superior soft soap containing salt conveniently. The soft soap prepared by the present invention contains a lot of salt, and thereby it softens skin, easily removes waste materials, prevents irritation, promotes blood circulation, and prevents depilation and dandruff.

While the present invention has been described in detail with reference to the preferred embodiments, those skilled in the art will appreciate that various modifications and substitutions can be made thereto without departing from the spirit and scope of the present invention as set forth in the appended claims.

1. A method for preparing monoglyceride sulfonate, which comprises:
a step of neutralizing a fatty acid derived from an animal oil such as tallow and lard, or from a plant oil selected from a group consisting of coconut oil, lauric acid, palm oil, and palm kernel oil, with an alkali metal solution in a solvent to prepare a single or mixed alkali metal salt of a fatty acid; and
a step of reacting the salt with a compound represented by the following Chemical Formula 2: 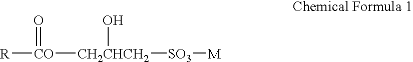
Chemical Formula 2
ClCH₂CH(OH)CH₂SO₃—M
wherein R is a C₇ to C₁₉ saturated or unsaturated aliphatic hydrocarbon radical, and M is sodium or potassium.

2. The method for preparing monoglyceride sulfonate according to claim 1, wherein the compound represented by Chemical Formula 2 is prepared by reacting epichlorohydrin with sodium sulfite, sodium bisulfite, or sodium metabisulfite.

3. The method for preparing monoglyceride sulfonate according to claim 1, wherein the alkali metal salt of a fatty acid and the compound represented by Chemical Formula 2 are reacted in the reaction equivalent ratio of 1:0.05 to 1.2.

4. The method for preparing monoglyceride sulfonate according to claim 1, wherein the solvent is water, or a mixture of water and a low alcohol.

5. A cleansing agent for a human body prepared by the method according to claim 1.

6. A soft soap composition comprising: 50 to 90 parts by weight of a mixture of monoglyceride sulfonate represented by the following Chemical Formula 1, which contains more than 60 wt % of lauric acid and myristic acid, and a fatty acid soap; 1 to 12 parts by weight of a fatty acid; and 1 to 25 parts by weight of a binder (plasticizer) or an excipient: 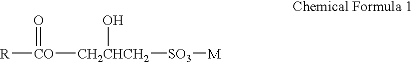
wherein R is a C₇ to C₂, alkyl; and M is sodium, potassium, triethanolamine, or ammonia.

7. The soft soap composition according to claim 6, wherein the mixing ratio of the monoglyceride sulfonate and the fatty acid soap is from 1:0.3 to 0.03:1.

8. The soft soap composition according to claim 6, wherein the content of the lauric acid and the myristic acid is over 70 wt %.

9. The soft soap composition according to claim 6, which further comprises 1 to 25 parts by weight of a surfactant.

10. A method for preparing a soft soap containing salt, which comprises:
(a) a step of neutralizing a C₈ to C₂₂ saturated or unsaturated fatty acid with caustic soda to obtain a fatty acid sodium salt represented by the following Chemical Formula 3a; and
(b) a step of reacting the fatty acid sodium salt with 3-chloro-2-hydroxypropanesulfonic acid sodium salt (SCHS) represented by the following Chemical Formula 2a in a solvent:
Chemical Formula 3a
RCOONa
wherein R is a C₇ to C₂₁ saturated or unsaturated aliphatic hydrocarbon; and
Chemical Formula 2a
ClCH₂CH(OH)CH₂SO₃Na

11. The method for preparing a soft soap containing salt according to claim 10, wherein in the step (a) the C₈ to C₂₂ saturated or unsaturated fatty acid is used alone or in combination.

12. The method for preparing a soft soap containing salt according to claim 10, wherein in the step (b) reaction equivalent ratio of the fatty acid sodium salt to the 3-chloro-2-hydroxypropanesulfonic acid sodium salt is from 1:0.1 to 1:1.2.

13. The method for preparing a soft soap containing salt according to claim 10, wherein the soft soap contains 2 to 15 wt % of salt.
